(19) United States
(12) Patent Application Publication
(10) Pub. No.: US 2007/0066783 A1
(43) Pub. Date: Mar. 22, 2007

(54) Silicone material having outstanding viscosity stability

(75) Inventors: Christof Woerner, Burghausen (DE); Frank Achenbach, Simbach am Inn (DE)

Correspondence Address: BROOKS KUSHMAN P.C., 1000 TOWN CENTER, TWENTY-SECOND FLOOR, SOUTHFIELD, MI, 48075, US

(73) Assignee: Wacker Chemie AG, Munich (DE)

(21) Appl. No.: 11/517,867

(22) Filed: Sep. 8, 2006

(30) Foreign Application Priority Data
Sep. 22, 2005 (DE) 10 2005 045 336.8

(51) Int. Cl. C08G 77/06

(52) U.S. Cl. 528/15

(57) ABSTRACT

Silicone materials, in particular crosslinkable silicone materials, which are distinguished by outstanding storage stability, as evidenced by substantially constant flowability and viscosity, are provided by incorporating from 10 ppm to 110 ppm ammonia or the equivalent amount of an ammonia liberating compound.

### BACKGROUND OF THE INVENTION

1. Field of the Invention

The present invention relates to silicone materials, in particular to crosslinkable silicone materials distinguished by outstanding storage stability, as reflected by constant flowability and viscosity.

2. Background Art

Silicone materials which are used for the preparation of silicone elastomers typically contain fillers, in particular reinforcing fillers, in order to impart sufficient mechanical strength and resilience to the silicone elastomers prepared therefrom. Customary reinforcing fillers are silicas and carbon blacks which have a specific surface area of at least 30 m²/g. However, as a result of their preparation, the pyrogenically prepared silicas which are most preferably employed, are initially obtained as hydrophilic particles, which greatly limits their use in silicone materials. The intensive interactions of the silica with polyorganosiloxanes, caused by the hydrophilic character of the silica, lead to a drastic increase in viscosity, ranging for example, from stiffening up to brittleness, with the result that the further processing of silicone material becomes more difficult or even impossible. In order to obtain readily flowable, viscosity-stable silicone materials, imparting hydrophobic properties to the silica is indispensable for this reason.

Hydrophobing of silica can be effected in a separate process step, as described in the German laid-open application DE 38 39 900 A1. The resulting hydrophobic silica can subsequently be dispersed in the polyorganosiloxanes in continuous or batch mixing units. In comparison, German patent DE 25 35 334 A1 describes the preparation of silicone materials, the hydrophilic silica being rendered hydrophobic in an in situ process by reaction with silazanes in the presence of polysiloxanes and water. Common to both variants is that in the end, a hydrophobic silica is present in the silicone material, which considerably improves the storage stability of the material with regard to its rheological behavior.

In spite of the improvement in the storage stability which is achieved by using hydrophobic silicas, a generally steady increase in viscosity of filler-containing silicone materials as a function of the storage time is still observed, with the result that processing behavior is adversely affected. Crosslinkable silicone materials prove critical here, especially when they contain SiH-containing compounds.

German laid-open application DE 103 53 062 A1 describes storage-stable, addition-crosslinkable, filler-containing silicone materials which have a content of SiOH groups which is specified as being low. Although a considerable improvement in the storage stability can be brought about in this manner, it is very difficult in terms of production technology to adjust the polymer's content of SiOH groups in the ppm range sufficiently accurately and reliably, which in turn results in variations in the rheological properties.

German laid-open application DE 195 45 365 A1 describes a process for the preparation of viscosity-stable, addition-crosslinkable organopolysiloxane materials which contain reinforcing oxidic fillers which have been rendered hydrophobic beforehand, wherein low molecular weight silanol compounds, such as, for example, trimethylsilanol, are added. This process has, inter alia, the disadvantage that these silanol compounds increase the proportion of volatile and extractable constituents and give rise to adverse odors during processing.

### SUMMARY OF THE INVENTION

It was therefore an object of the present invention to overcome the disadvantages of the prior art, and to improve the storage stability of silicone materials which contain pyrogenically prepared, hydrophobic silica and SiH crosslinking agents in a manner which is simple in terms of production technology. It has now been surprisingly discovered that not only is the degree of hydrophobing of the silica of great importance, but that the storage stability of the silicone material can be decisively improved by providing a specified low ammonia content, particularly when silicone materials containing SiH compounds are employed.

### DETAILED DESCRIPTION OF THE PREFERRED EMBODIMENT(S)

The invention is thus based on the discovery that, at a certain low ammonia content of from at least 10 to not more than 110 ppm by weight, corresponding to 8-90 ppm by weight of nitrogen, silicone materials which contain pyrogenically prepared silica which has been rendered hydrophobic and SiH-containing crosslinking agents, exhibit excellent storage stability. This is evident from the fact that, at an ammonia content of 10-110 ppm by weight, an increase in viscosity is completely prevented or is at least drastically reduced over a period of several months. This improvement occurs not only at customary storage temperatures of up to 35° C., but is even to be found at higher storage temperatures (e.g. 50° C.).

The present invention therefore relates to storage-stable addition-crosslinkable silicone materials containing
(A) 100 parts by weight of at least one polydiorganosiloxane having an average degree of polymerization of from 20 to 10,000 and a proportion of from 0.02 to 20 mol % of alkenyl-functional organosilyloxy units,
(B) 5-90 parts by weight of at least one pyrogenically prepared silica which has been rendered hydrophobic and has a specific surface area of at least 50 m²/g,
(C) 0.1-50 parts by weight of at least one organosilicon compound which contains at least three hydrogen atoms per molecule which are bonded to silicon,
(D) 10-110 ppm by weight, based on the total mass of the constituents (A) to (C), of ammonia or a proportion of a compound liberating ammonia, with the proviso that this proportion corresponds to a liberation of 10-110 ppm by weight of ammonia, the liberation of the ammonia preferably taking place thermally or hydrolytically, and
(E) a hydrosilylation catalyst,
   wherein the constitutents (A) to (E) can be combined into a single component or may be present in a plurality of components.

The formation of two components is preferred, one containing the hydrosilylation catalyst (E) and the other the SiH-containing crosslinking agent (C).

The composition of the polydiorganosiloxane (A) preferably corresponds to the average general formula (1)
R¹ₓR²_{y}SiO_{(4-x-y)/2} (1)
in which
R¹ is a monovalent, optionally halogen- or cyano-substituted C₁₋₁₀ hydrocarbon radical which is optionally bonded to silicon via an organic divalent group and contains aliphatic carbon-carbon multiple bonds,
R² is an OH group or a monovalent, optionally halogen- or cyano-substituted C₁₋₁₀ hydrocarbon radical which is bonded via SiC and contains no aliphatic carbon-carbon multiple bonds,
x is a positive number, with the proviso that on average at least two radicals R¹ are present per polydiorganosiloxane chain, and
y is a number from 1.6 to 2.0,
   in which the radicals R¹ and R² may in each case be identical or different.

The alkenyl groups R¹ are capable of undergoing an addition reaction with an SiH-functional crosslinking agent. Usually, alkenyl groups having 2 to 6 carbon atoms, such as vinyl, allyl, methallyl, 1-propenyl, 5-hexenyl, ethynyl, butadienyl, hexadienyl, cyclopentenyl, cyclopentadienyl, or cyclohexenyl, preferably vinyl and allyl, are used. The radicals R¹ may be bonded in any position of the polymer chain, in particular to the terminal silicon atoms.

Examples of unsubstituted radicals R² are alkyl radicals such as the methyl, ethyl, n-propyl, isopropyl, n-butyl, isobutyl, tert-butyl, n-pentyl, isopentyl, neopentyl and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical; alkenyl radicals such as the vinyl, allyl, n-5-hexenyl, 4-vinylcyclohexyl and 3-norbornenyl radicals; cycloalkyl radicals such as the cyclopentyl, cyclohexyl, 4-ethylcyclohexyl, cycloheptyl, norbornyl, and methylcyclohexyl radicals; aryl radicals such as the phenyl, biphenylyl and naphthyl radicals; alkaryl radicals such as o-, m-, p-tolyl radicals and ethylphenyl radicals; aralkyl radicals such as the benzyl radical, and the α- and the β-phenylethyl radicals. Examples of substituted hydrocarbon radicals as radicals R² are halogenated hydrocarbons, for example the chloromethyl, 3-chloropropyl, 3-bromopropyl, 3,3,3-trifluoropropyl and 5,5,5,4,4,3,3-heptafluoropentyl radicals, and the chlorophenyl, dichlorophenyl and trifluorotolyl radicals. R² preferably has 1 to 6 carbon atoms. Methyl, 3,3,3-trifluoropropyl and phenyl radicals are particularly preferred.

The structure of the polydiorganosiloxanes (A) containing alkenyl groups may be linear, cyclic or branched. The content of tri- and/or tetrafunctional units carrying branched polyorganosiloxanes is typically very low, preferably not more than 20 mol %, in particular not more than 0.1 mol %. The use of linear polydimethylsiloxanes containing vinyl groups and having a viscosity of preferably from 0.2 to 5000 Pas, in particular from 1 to 2000 Pas, at 25° C. is particularly preferred.

Constituent (B) of the silicone material according to the invention is finely divided, pyrogenically prepared silica which has been rendered hydrophobic and has a specific surface area, measured according to BET, of at least 50 m²/g, preferably from 100 to 800 m²/g, and most preferably from 150 to 400 m²/g. Surface treatment can be achieved by processes well known to those skilled in the art of hydrophobing finely divided solids. The hydrophobing can be effected either before the incorporation into the polyorganosiloxane or in the presence of a polyorganosiloxane in accordance with the in situ process. Both processes can be carried out either as a batch process or continuously. Preferably used hydrophobing agents are organosilicon compounds which are capable of reacting with the filler surface with formation of covalent bonds or are permanently physisorbed on the filler surface.

In a preferred embodiment, the hydrophobing of the pyrogenically prepared silica is effected in a separate process step, as described, for example, in German laid-open application DE 38 39 900 A1. This has the advantage that the subsequent mixing with the polydiorganosiloxane (A) can be effected in an effective manner in a continuously operating mixing unit. However, the high shear forces which occur on dispersing a pyrogenically prepared, prehydrophobed silica in a polydiorganosiloxane result in partial destructuring of the silica and hence exposure of only partially hydrophobed or completely unhydrophobed areas of the silica surface, with the result that the storage stability of the resulting crosslinkable silicone materials is adversely affected. However, the silicone materials prepared in this manner can be stabilized in a particularly sustained manner by the low ammonia content according to the invention.

Preferred hydrophobing agents correspond to the general formulae (2) or (3)
R³₄₋ₐSiAₐ (2)
(R³₃Si)_{b}B (3),
in which
R³ are each identical or different and are monovalent, aliphatically saturated or unsaturated, halogen-substituted or unsubstituted hydrocarbon radicals having 1 to 12 carbon atoms,
A is halogen, —OH, —OR⁴ or —OCOR⁴,
B is —NR⁵_{3-b},
R⁴ is a monovalent hydrocarbon radical having 1 to 12 carbon atoms,
R⁵ is a hydrogen atom or has the same meaning as R³,
a is 1, 2 or 3, and
b is 1 or 2;
   or are an organopolysiloxane hydrophobing agents comprising units of the general formula (4)
   R³_{z}SiO(_{4-z)/2} (4),
   in which
R³ has the above-mentioned meaning, and
z is 1, 2, or 3.

Hydrophobing agents include, for example, alkylchlorosilanes such as methyltrichlorosilane, dimethyldichlorosilane, trimethylchlorosilane, octyltrichlorosilane, octadecyltrichlorosilane, octylmethyldichlorosilane, octadecylmethyldichlorosilane, octyldimethylchlorosilane, octadecyldimethylchlorosilane and tert-butyldimethylchlorosilane; alkylalkoxysilanes such as dimethyldimethoxysilane, dimethyldiethoxysilane, trimethylmethoxysilane and trimethylethoxysilane; trimethylsilanol; cyclic diorgano(poly)siloxanes such as octamethylcyclotetrasiloxane, decamethylcyclopentasiloxane; linear diorganopolysiloxanes such as dimethylpolysiloxanes having trimethylsilyloxy terminal groups and dimethylpolysiloxanes having silanol or alkoxy terminal groups; disilazanes, hexaalkyldisilazanes, in particular hexamethyldisilazane, divinyltetramethyldisilazane, bis(trifluoropropyl)tetramethyldisilazane; and cyclic dimethylsilazanes such as hexamethylcyclotrisilazane.

It is also possible to use mixtures of the abovementioned hydrophobing agents. In order to accelerate the hydrophobing, the addition of catalytically active additives, for example amines or metal hydroxides, is also possible. The hydrophobing can be effected in one step with the use of one or more hydrophobing agents, but also with the use of one or more hydrophobing agents in a plurality of steps.

As a result of a surface treatment, preferred fillers have a carbon content of at least 0.01 to not more than 20% by weight, preferably from 0.1 to 10% by weight, and most preferably from 0.5 to 5% by weight. Surface-treated silicas having a content of from 0.01 to 2% by weight of aliphatically unsaturated groups, for example Si-bonded vinyl groups, are particularly preferred.

Constituent (C) is an SiH-functional crosslinking agent whose composition corresponds to the average formula (5)
HₘR²ₙSiO(_{4-m-n)/2} (5)
in which
R² has the abovementioned meaning,
m is a positive number, the relationship 0.005≦m≦1 being fulfilled, and
n is a positive number, the relationship 0.005≦n≦2 being fulfilled,
   with the proviso that on average at least 3 Si-bonded hydrogen atoms are present per molecule of crosslinking agent.

The hydrogen content of the crosslinking agent (C), which relates exclusively to hydrogen atoms bonded directly to silicon atoms, is preferably in the range of from 0.002 to 1.7% by weight of hydrogen, more preferably from 0.1 to 1.7% by weight. The crosslinking agent (C) contains at least 3 and not more than 600 silicon atoms per molecule, preferably from 4 to 200 silicon atoms. The structure of the crosslinking agent (C) may be linear, branched, cyclic or resin- or network-like. The radicals R² present in the crosslinking agent (C) are preferably chosen so that they are compatible with the radicals present in the constituent (A), so that the constituents of (A) and (C) are miscible. Particularly preferred crosslinking agents are poly(dimethylsiloxane-co-methylhydrogensiloxanes).

The crosslinking agent (C) is preferably present in the crosslinkable silicone rubber material in an amount such that the molar ratio of SiH groups to the alkenyl-functional units of the constituent (A) is from 0.5 to 5, in particular from 1.0 to 3.0. The crosslinking agent (C) may also be a mixture of different crosslinking agents.

Constituent (D) is ammonia or an ammonia-liberating compound.

The preparation of silicone materials which have an ammonia content of from 10 to 110 ppm by weight can be effected in principle in any desired manner. For example, gaseous ammonia can be passed directly into the silicone material. However, the addition and the mixing in of an aqueous ammonia solution of known concentration is expedient, facilitating the establishment of the desired ammonia content. Furthermore, ammonia-liberating compounds can be metered into the silicone material provided that they do not form any undesired byproducts in the silicone material. Suitable ammonia-liberating compounds are, for example, silazanes, such as, for example, hexamethyldisilazane and divinyltetramethyldisilazane, which are capable of undergoing hydrolysis and liberating ammonia in the presence of silicas. Further compounds forming ammonia by hydrolysis are the amides, imides and nitrides of the alkali metals and alkaline earth metals. If the preparation of the silicone material is effected by the in situ process mentioned at the outset with the use of silazanes as hydrophobing agents, a considerable amount of ammonia is liberated during the hydrophobing step, so that for this reason alone heating of the silicone material is indispensable, at the same time undesired volatile residues, such as, for example, silazane residues, water, silanols, short-chain siloxanes or cyclic structures, also being removed. This in situ process therefore offers a further possibility of establishing the desired ammonia content in a controlled manner by suitably establishing the heating conditions, such as, for example, temperature, vacuum or kneading time. Compounds eliminating ammonia thermolytically are, for example, ammonium carbonate, ammonium bicarbonate and urea.

Ammonia contents of from 10 to 80 ppm by weight, based on the total mass of the constituents A, B, C and D are preferred. A lowering of the ammonia content to less than 10 ppm by weight leads to a deterioration in the storage stability, i.e. to a viscosity increase corresponding to the prior art during storage. While the deterioration in the storage stability at ammonia contents which are too low tends to be moderate, excessively high ammonia contents of more than 110 ppm lead not only to a drastic deterioration in the storage stability, i.e. to a dramatic increase in viscosity, but in addition to a disadvantageous reduction of the crosslinking rate, for example due to the inhibition of the hydrosilylation catalyst, to lower modulus of the silicone elastomer and increasing tack in the mold when processing by injection molding.

The excellent viscosity stability of the silicone materials according to the invention which contain from 10 to 110 ppm by weight of ammonia indicates that the presence of ammonia in the range according to the invention either causes the formation of rheologically active species in the silicone material, which promote the flowability and the viscosity stability and in this way counteract the formation of structure, or the high affinity of the ammonia to the filler is associated with desorption of polymer chains bridging filler aggregates, which likewise excludes the formation of structure by polymer-bridged silica aggregates.

The advantage according to the invention of silicone materials containing from 10 to 110 ppm by weight of ammonia consists in the excellent storage stability with respect to the theological properties, even if they contain pyrogenically prepared silica which has been rendered hydrophobic and SiH crosslinking agent. In addition, the ammonia content in the claimed (low) range is not associated with any adverse affects at all, such as tack in the mold, decrease in hardness, slowing down of the crosslinking rate, etc. The mechano-elastic property profile of the elastomers prepared from the silicone materials according to the invention also shows no changes at all due to the content of ammonia in the uncrosslinked material.

The addition-crosslinkable silicone materials which are claimed in European Patent EP 0 731 131 B1 contain pyrogenically prepared silica and have an ammonia content, calculated as nitrogen and based on the total mass of the constituents (A), (C) and (E), of from 10 to 500 ppm by weight, corresponding to an ammonia content of from 12 to 607 ppm by weight, for the purpose of reducing the compression set of the unannealed silicone elastomer prepared therefrom. The reduction in the compression set as a result of addition of aqueous ammonia is demonstrated for the silicone materials containing pyrogenic silica described in the European Patent EP 0 731 131 B1, in example 5 and comparative example 4. Surprisingly, this reduction of the values of the compression set cannot be demonstrated on either the unannealed or the annealed silicone elastomers which were prepared from the silicone materials which are investigated here, contain pyrogenic silica and have an ammonia content of from 10 to 110 ppm by weight. As will be shown in the examples, ammonia contents of from 10 to 110 ppm by weight in fact have no influence on the compression set. A further increase in the ammonia content above 110 ppm by weight is even associated with an increase in deterioration of the compression set both of the unannealed and of the annealed silicone elastomers. The relationship between ammonia content and rheological behavior of the silicone material is not disclosed or suggested at any point in the patent EP 0 731 131 B1. Rather, the high ammonia contents of up to 500 ppm by weight which are claimed in the European Patent EP 0 731 131 B1 result in SiH groups of the crosslinking agent being hydrolyzed faster, i.e. under catalysis, to SiOH groups during the storage time owing to the presence of traces of moisture, which in turn leads to an increase in viscosity, causes disturbances in the vulcanization and results in increased values in the compression set.

The addition reaction between the alkenyl groups of the constituent (A) and the SiH groups of the crosslinking agent (C), which is referred to as hydrosilylation, is preferably effected in the presence of a catalyst. In principle, all hydrosilylation catalysts corresponding to the prior art and typically used in addition-crosslinkable silicone rubber materials can be used. These are in particular metals, such as platinum, rhodium, palladium, ruthenium and iridium, and organometallic compounds derived from these; platinum and platinum compounds are preferred, and complex compounds of platinum with vinylsiloxanes, such as, for example, sym-divinyltetramethyldisiloxane (Karstedt catalyst), are particularly preferred.

The amount of hydrosilylation catalyst used depends substantially on the desired crosslinking rate and economic points of view. The content of hydrosilylation catalyst in an addition-crosslinkable total silicone rubber material according to the invention (based on the metal present therein) is preferably from 0.05 to 1000 ppm by weight, particularly preferably from 1 to 100 ppm by weight.

Thus, this invention furthermore relates to a process for the preparation of silicone elastomers, wherein a silicone material according to the invention is used. A process in which the silicone elastomers are crosslinked by means of an addition reaction is particularly preferred here. The abovementioned hydrosilylation catalysts are preferably used here.

This invention furthermore relates to silicone elastomers which are obtained by a process for crosslinking the silicone material according to the invention.

### EXAMPLES

By way of example, the ammonia content can be determined with the aid of nitrogen analyzers, the sample substance being pyrolyzed at high temperatures and the nitrogen compounds liberated being oxidized. The energy liberated can be measured in a chemiluminescence detector. It is also possible to use other methods for determining the nitrogen content or ammonia content.

The characterization of the silicone elastomer properties was effected according to DIN 53505 (Shore A) and DIN 53517 (compression set). The viscosity was determined at a temperature of 25° C. and a shear rate of 0.9 s⁻¹.

### Example 1 (Not According to the Invention)

156 g of a vinyldimethylsilyloxy-terminated polydimethylsiloxane having a viscosity of 20,000 mPa·s (25° C.) were initially introduced into a kneader and mixed with 27 g of hexamethyldisilazane and 9.3 g of water, then mixed with 100 g of pyrogenic silica having a BET surface area of 300 m²/g, heated to 100° C. and then kneaded for 1 hour. Thereafter, volatile constituents were removed in vacuo at 150° C. for 24 hours and dilution was then effected with 141 g of vinyldimethylsilyloxy-terminated polydimethylsiloxane having a viscosity of 20,000 mPa·s.

3.5 g of a copolymer comprising dimethylsilyloxy, methylhydrogensilyloxy and trimethylsilyloxy units, having a viscosity of 300 mPa·s at 25° C. and a (Si)H content of 0.48% by weight, were added to 100 g of the material prepared above. The ammonia content of this mixture was 5 ppm (4 ppm of nitrogen).

### Example 2 (According to the Invention)

In contrast to example 1, volatile constituents were removed in vacuo at 150° C. for 2 hours. 3.5 g of a copolymer comprising dimethylsilyloxy, methylhydrogensilyloxy and trimethylsilyloxy units, having a viscosity of 300 mPa·s at 25° C. and a (Si)H content of 0.48% by weight, were added to 100 g of the material prepared above. The ammonia content of this mixture was 15 ppm (12 ppm of nitrogen).

### Example 3 (According to the Invention)

In contrast to example 1, volatile constituents were removed in vacuo at 150° C. for 1 hour. 3.5 g of a copolymer comprising dimethylsilyloxy, methylhydrogensilyloxy and trimethylsilyloxy units, having a viscosity of 300 mPa·s at 25° C. and a (Si)H content of 0.48% by weight, were added to 100 g of the material prepared above. The ammonia content of this mixture was 40 ppm (33 ppm of nitrogen).

### Example 4 (According to the Invention)

In contrast to example 1, volatile constituents were removed in vacuo at 150° C. for 30 minutes. 3.5 g of a copolymer comprising dimethylsilyloxy, methylhydrogensilyloxy and trimethylsilyloxy units, having a viscosity of 300 mPa·s at 25° C. and a (Si)H content of 0.48% by weight, were added to 100 g of the material prepared above. The ammonia content of this mixture was 70 ppm (58 ppm of nitrogen).

### Example 5 (Not According to the Invention)

In contrast to example 1, volatile constituents were removed in vacuo at 150° C. for 20 minutes. 3.5 g of a copolymer comprising dimethylsilyloxy, methylhydrogensilyloxy and trimethylsilyloxy units, having a viscosity of 300 mPa·s at 25° C. and a (Si)H content of 0.4% by weight, were added to 100 g of the material prepared above. The ammonia content of this mixture was 150 ppm (124 ppm of nitrogen).

### Example 6 (Not According to the Invention)

In contrast to example 1, volatile constituents were removed in vacuo at 150° C. for 10 minutes. 3.5 g of a copolymer comprising dimethylsilyloxy, methylhydrogensilyloxy and trimethylsilyloxy units, having a viscosity of 300 mPa·s at 25° C. and a (Si)H content of 0.48% by weight, were added to 100 g of the material prepared above. The ammonia content of this mixture was 250 ppm (206 ppm of nitrogen).

TABLE 1
Influence of the ammonia content on the storage stability at 25 and 50° C.

| | Ammonia | | | |
|---|---|---|---|---|
| | content of | Viscosity of the | | |
| | the uncrosslinked | silicone material [Pa · s] | | |
| | silicone material | | after 4 weeks | after 4 weeks |
| Example | [ppm] | Initially | at 25° C. | at 50° C. |
| 1* | 5 | 1030 | 1090 | 1110 |
| 2 | 15 | 700 | 690 | 710 |
| 3 | 40 | 710 | 720 | 750 |
| 4 | 70 | 690 | 750 | 770 |
| 5* | 150 | 720 | 950 | 1190 |
| 6* | 250 | 740 | 1230 | 1860 |

*not according to the invention

From Table 1, it is evident that a low ammonia content of 10-110 ppm ensures a low initial viscosity and sufficient storage stability, and the absence of ammonia and high ammonia contents not according to the invention lead to an increase in the viscosity of the silicone material.

### Example 7 (Not According to the Invention)

0.08 g of a solution having a Pt content of 1% by weight, which contains a platinum-sym-divinyltetramethyldisiloxane complex, and 0.07 g of ethynylcyclohexanol were added to 100 g of the mixture prepared in example 1, which contained 3.5% by weight of SiH crosslinking agent. This addition-crosslinking silicone material was then crosslinked in a hydraulic press at a temperature of 165° C. in the course of 2 minutes to give a silicone elastomer film having a hardness of 40 Shore A. The ammonia content of this crosslinked, unannealed silicone elastomer film was 7 ppm. The compression set was 58 % (22 hours, 175° C.). After annealing for 4 hours at 200° C., the ammonia content was 6 ppm and the compression set could be reduced to 15% (22 hours, 175° C.).

### Example 8 (According to the Invention)

In contrast to example 7, the mixture prepared in example 2 was used.

### Example 9 (According to the Invention)

In contrast to example 7, the mixture prepared in example 3 was used.

### Example 10 (According to the Invention)

In contrast to example 7, the mixture prepared in example 4 was used.

### Example 11 (Not According to the Invention)

In contrast to example 7, the mixture prepared in example 5 was used.

### Example 12 (Not According to the Invention)

In contrast to example 7, the mixture prepared in example 6 was used.

TABLE 2
Influence of the ammonia content on the compression
set of unannealed silicone elastomer films

| | Hardness of the | Ammonia content | Compressions set of |
|---|---|---|---|
| | unannealed | of the crosslinked, | the unannealed |
| | silicone elastomer | unannealed | silicone elastomer |
| | film | silicone elastomer | film |
| Example | [Shore A] | [ppm] | [%] |
| 7* | 40 | 7 | 58 |
| 8 | 41 | 13 | 59 |
| 9 | 40 | 37 | 58 |
| 10 | 40 | 65 | 59 |
| 11* | 36 | 140 | 66 |
| 12* | 30 | 210 | 87 |

*not according to the invention

From Table 2, it is evident that an ammonia content of 10-110 ppm has no influence on the compression set of unannealed silicone elastomers. However, an increase in the ammonia content to above 110 ppm adversely affects the compression set of unannealed silicone elastomers.

TABLE 3
Influence of the ammonia content on the compression
set of annealed silicone elastomer films

| | | Ammonia content | Compressions set of |
|---|---|---|---|
| | Hardness of the | of the crosslinked, | the annealed |
| | annealed silicone | annealed silicone | silicone |
| | elastomer film | elastomer | elastomer film |
| Example | [Shore A] | [ppm] | [%] |
| 7* | 41 | 6 | 15 |
| 8 | 41 | 11 | 14 |
| 9 | 40 | 16 | 16 |
| 10 | 41 | 16 | 16 |
| 11* | 40 | 21 | 25 |
| 12* | 41 | 24 | 29 |

*not according to the invention

From Table 2, it is evident that an ammonia content of 10-110 ppm has no influence on the compression set of annealed silicone elastomers. However, an increase in the ammonia content of silicone elastomers prior to annealing to above 110 ppm adversely affects the compression set of annealed silicone elastomers.

TABLE 4
Influence of the ammonia content on the tack in
the mold in the injection molding process

| | Ammonia content of the | |
|---|---|---|
| | crosslinked, unannealed | |
| | silicone elastomer | |
| Example | [ppm] | Removal from the mold |
| 7* | 7 | good |
| 8 | 13 | good |
| 9 | 37 | good |
| 10 | 65 | good |
| 11* | 140 | poor/tacky |
| 12* | 210 | poor/tacky |

*not according to the invention

From Table 4, it is evident that an ammonia content of more than 110 ppm has adverse effects on the processability in injection molding.

### Example 13 (Not According to the Invention)

156 g of a vinyldimethylsilyloxy-terminated polydimethylsiloxane having a viscosity of 20,000 mPa·s (25° C.) were initially introduced into a kneader and mixed with 110 g of pyrogenic silica which had been rendered hydrophobic beforehand and had a BET surface area of 300 m²/g, a carbon content of 4% and an ammonia content of 820 ppm, heated to 100° C. and then kneaded for 1 hour. Thereafter, volatile constituents were removed in vacuo at 150° C. for 24 hours and dilution was then effected with 141 g of vinyldimethylsilyloxy-terminated polydimethylsiloxane having a viscosity of 20,000 mPa·s.

3.5 g of a copolymer comprising dimethylsilyloxy, methylhydrogensilyloxy and trimethylsilyloxy units, having a viscosity of 300 mPa·s at 25° C. and a (Si)H content of 0.48% by weight, were added to 100 g of the material prepared above. The ammonia content of this mixture was 6 ppm (5 ppm of nitrogen).

### Example 14 (According to the Invention)

In contrast to example 13, volatile constituents were removed in vacuo at 150° C. for 1 hour. 3.5 g of a copolymer comprising dimethylsilyloxy, methylhydrogensilyloxy and trimethylsilyloxy units, having a viscosity of 300 mPa·s at 25° C. and an SiH content of 0.48%, were added to 100 g of the material prepared above. The ammonia content of this mixture was 50 ppm (41 ppm of nitrogen).

### Example 15 (Not According to the Invention)

In contrast to example 13, volatile constituents were removed in vacuo at 150° C. for 10 minutes. 3.5 g of a copolymer comprising dimethylsilyloxy, methylhydrogensilyloxy and trimethylsilyloxy units, having a viscosity of 300 mPa·s at 25° C. and an SiH content of 0.48%, were added to 100 g of the material prepared above. The ammonia content of this mixture was 205 ppm (169 ppm of nitrogen).

TABLE 5
Influence of the ammonia content on the storage stability at 25 and 50° C.

| | Ammonia | | | |
|---|---|---|---|---|
| | content of | Viscosity of the silicone | | |
| | the uncrosslinked | material [Pa · s] | | |
| | silicone material | | after 4 weeks | after 4 weeks |
| Example | [ppm] | Initially | at 25° C. | at 50° C. |
| 13* | 6 | 1100 | 1150 | 1240 |
| 14 | 50 | 850 | 840 | 920 |
| 15* | 205 | 840 | 1120 | 1980 |

*not according to the invention

From Table 5, it is evident that a low ammonia content of 10-110 ppm according to the invention ensures a low initial viscosity and sufficient storage stability.

### Example 16 (Not According to the Invention)

0.08 g of a solution having a Pt content of 1% by weight, which contains a platinum-sym-divinyltetramethyldisiloxane complex, and 0.07 g of ethynylcyclohexanol were added to 100 g of the mixture prepared in example 13, which contained 3.5% by weight of SiH crosslinking agent. This addition-crosslinking silicone material was then crosslinked in a hydraulic press at a temperature of 165° C. in the course of 2 minutes to give a silicone elastomer film having a hardness of 42 Shore A. The ammonia content of this crosslinked, unannealed silicone elastomer film was 5 ppm. The compression set was 55% (22 hours, 175° C.). After annealing for 4 hours at 200° C., the ammonia content was 5 ppm and the compression set could be reduced to 11% (22 hours, 175° C.).

### Example 17 (According to the Invention)

In contrast to example 16, the mixture prepared in example 14 was used.

### Example 18 (Not According to the Invention)

In contrast to example 16, the mixture prepared in example 15 was used.

| | | Ammonia content of | Compression set |
|---|---|---|---|
| | Hardness of the | the crosslinked, | of the unannealed |
| | unannealed silicone | unannealed silicone | silicone elastomer |
| | elastomer film | elastomer | film |
| Example | [Shore A] | [ppm] | [%] |
| 16* | 42 | 5 | 55 |
| 17 | 41 | 45 | 54 |
| 18* | 32 | 180 | 69 |

*not according to the invention

From Table 6, it is evident that an ammonia content of 10-110 ppm has no significant influence on the compression set of unannealed silicone elastomers. However, an increase in the ammonia content to above 110 ppm adversely affects the compression set of unannealed silicone elastomers.

TABLE 7
Influence of the ammonia content on the compression
set of annealed silicone elastomer films

| | | Ammonia content of | Compression set |
|---|---|---|---|
| | Hardness of the | the crosslinked, | of the unannealed |
| | annealed silicone | annealed silicone | silicone elastomer |
| | elastomer film | elastomer | film |
| Example | [Shore A] | [ppm] | [%] |
| 16* | 42 | 5 | 11 |
| 17 | 42 | 11 | 10 |
| 18* | 41 | 20 | 26 |

*not according to the invention

From Table 7, it is evident that an ammonia content of 10-110 ppm present prior to annealing has no significant influence on the compression set of annealed silicone elastomers. However, an ammonia content of more than 110 ppm present prior to annealing also adversely affects the compression set of the annealed silicone elastomers.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A storage-stable addition-crosslinkable silicone material comprising:
(A) 100 parts by weight of at least one polydiorganosiloxane having an average degree of polymerization of from 20 to 10,000 and a proportion of from 0.02 to 20 mol % of alkenyl-functional organosilyloxy units,
(B) 5-90 parts by weight of at least one pyrogenically prepared silica which has been rendered hydrophobic and has a specific surface area of at least 50 m²/g,
(C) 0.1-50 parts by weight of at least one organosilicon compound which contains at least three hydrogen atoms per molecule which are bonded to silicon,
(D) 10-110 ppm by weight, based on the total mass of the constituents (A) to (C), of ammonia or a proportion of a compound liberating ammonia, with the proviso that this proportion corresponds to liberation of 10-110 ppm by weight of ammonia, and
(E) a hydrosilylation catalyst,
wherein the constitutents (A) to (E) are combined into a single component or are present in a plurality of components.

2. The silicone material of claim 1, wherein the silicone material consists of two components, with the proviso that one contains the hydrosilylation catalyst (E) and the other contains the SiH-containing crosslinking agent (C).

3. The silicone material of claim 1, wherein the polydiorganosiloxane (A) corresponds to the average general formula (1)
R¹ₓR²_{y}SiO_{(4-x-y)/2} (1)
in which
R¹ is a monovalent, optionally halogen- or cyano-substituted C₁₋₁₀ hydrocarbon radical which is optionally bonded to silicon via an organic divalent group and contains aliphatic carbon-carbon multiple bonds,
R² is an OH group or a monovalent, optionally halogen- or cyano-substituted C₁₋₁₀ hydrocarbon radical which is bonded via SiC and contains no aliphatic carbon-carbon multiple bonds,
x is a positive number, with the proviso that on average at least two radicals R¹ are present per polydiorganosiloxane chain, and
y is a number from 1.6 to 2.0,
in which the radicals R¹ and R² in each case are identical or different.

4. The silicone material of claim 1, wherein at least one compound of the general formula (2) or (3)
R³₄₋ₐSiAₐ (2)
(R³₃Si)_{b}B (3),
in which
R³ are identical or different and are a monovalent, aliphatically saturated or unsaturated, halogen-substituted or unsubstituted hydrocarbon radical having 1 to 12 carbon atoms,
A is a halogen, —OH, —OR⁴ or —OCOR⁴, and
B is —NR⁵_{3-b},
R⁴ is a monovalent hydrocarbon radical having 1 to 12 carbon atoms,
R⁵ is a hydrogen atom or has the same meaning as R³,
a is 1, 2 or 3,
b is 1 or 2,
or an organopolysiloxane comprising units of the formula (4)
R³_{z}SiO_{(4-z)/2} (4),
in which
R³ has the above-mentioned meaning, and
z is 1, 2, or 3,
or a mixture thereof,
is used as the hydrophobing agent of the pyrogenically prepared silica (B).

5. The silicone material of claim 1, wherein constituent (C) is an SiH-functional crosslinking agent having the average formula (5)
HₘR²ₙSiO_{(4-m-n)/2} (5)
in which
R² has the abovementioned meaning,
m is a positive number, the relationship 0.005≦m≦1 being fulfilled, and
n is a positive number, the relationship 0.005≦n≦2 being fulfilled,
with the proviso that on average at least 3 Si-bonded hydrogen atoms are present per molecule of crosslinking agent.

6. The silicone material of claim 1, wherein the hydrophobing of the pyrogenically prepared silica (B) is effected in a separate process step prior to mixing with polydiorganosiloxane (A).

7. The silicone material of claim 1, wherein ammonia (D) is added in gaseous form or in aqueous solution.

8. The silicone material of claim 1, wherein the ammonia (D) is added in the form of at least one compound selected from the group consisting of silazanes, amides, imides and nitrides of the alkali metals and alkaline earth metals, which compound forms the ammonia (D) in the silicone material.

9. The silicone material of claim 1, which contains, based on the total mass of the constituents (A) to (C), 10-80 ppm by weight of ammonia or a proportion of an ammonia-liberating compound which corresponds to the liberation of 10-80 ppm by weight of ammonia.

10. A process for the preparation of a silicone material of claim 1, in comprising combining:
(A) 100 parts by weight of at least one polydiorganosiloxane having an average degree of polymerization of from 20 to 10,000 and a proportion of from 0.02 to 20 mol % of alkenyl-functional organosilyloxy units,
(B) 5-90 parts by weight of at least one pyrogenically prepared silica which has been rendered hydrophobic and has a specific surface area of at least 50 m²/g,
(C) 0.1-50 parts by weight of at least one organosilicon compound which contains at least three hydrogen atoms bonded to silicon per molecule,
(D) 10-110 ppm by weight, based on the total mass of the constituents (A) to (C), of ammonia or a proportion of an ammonia-liberating compound, with the proviso that this proportion corresponds to the liberation of 10-110 ppm by weight of ammonia, the liberation of the ammonia preferably taking place thermally or hydrolytically, and
(E) a hydrosilylation catalyst,
to form a single component or a plurality of components.

11. The process of claim 10, wherein hydrophobing of the finely divided solids (B) is effected in the presence of a polyorganosiloxane by the in situ process.

12. The process of claim 10, wherein the hydrophobing of the finely divided solids (B) is effected prior to incorporation into the polyorganosiloxane.

13. The process of claim 10, wherein the process is effected batchwise or continuously.

14. A process for the preparation of silicone elastomers, comprising crosslinking a silicone material of claim 1.

15. The process of claim 14, wherein the silicone elastomers are crosslinked by an addition reaction.

16. A silicone elastomer prepared by the process of claim 14.
